(19) United States
(12) Patent Application Publication
(10) Pub. No.: US 2018/0049419 A1
(43) Pub. Date: Feb. 22, 2018

(54) COMPOSITIONS WITH INCREASED WET STRENGTH AND METHODS OF MANUFACTURE

(71) Applicants: Raymond M. Robertson, Blacksburg, VA (US); Michael T. Combs, Pembroke, VA (US); Amanda G. Combs, Pembroke, VA (US); Michael Joshua Combs, Pembroke, VA (US)

(72) Inventors: Raymond M. Robertson, Blacksburg, VA (US); Michael T. Combs, Pembroke, VA (US); Amanda G. Combs, Pembroke, VA (US); Michael Joshua Combs, Pembroke, VA (US)

(21) Appl. No.: 15/678,911

(22) Filed: Aug. 16, 2017

Related U.S. Application Data
(60) Provisional application No. 62/375,477, filed on Aug. 16, 2016.

(51) Int. Cl. A01K 97/04; A23K 50/80

(52) U.S. Cl. CPC A01K 97/045; A23K 50/80

(57) ABSTRACT

Compositions and methods useful for fishing are described. In particular, compositions which include one or more fish attractants and which combine several advantageous properties, including moldability at ambient temperatures, sustained release of attractant(s), and ability to resist casting forces due to increased wet strength, are described. These advantages are achieved by combining a polymer such as a cellulose ester, a plasticizer, one or more fish attractant food sources, and optionally one or more fillers. The compositions may include up to 50% attractants, rendering them an effective bait material for attracting fish, crustaceans, other aquatic creatures such as marine mammals, mink, beaver, nuisance pests such as insects, rodents, and coyotes or game species such as deer and bear.

### CROSS-REFERENCE TO RELATED APPLICATIONS

The present application relies on the disclosure of and claims priority to and the benefit of the filing date of U.S. Provisional Application No. 62/375,477, filed Aug. 16, 2016, the disclosure of which is hereby incorporated by reference herein in its entirety.

### BACKGROUND OF THE INVENTION

### Field of the Invention

The present invention generally relates to compositions and methods employing attractants that can be used for commercial or recreational fishing or any application in which baiting is used, including hunting or trapping. More particularly, embodiments of the present invention relate to compositions with a putty-like consistency that can be used as bait, which possesses several advantageous properties, including moldability, sustained release of attractants, and ability to resist casting forces due to increased wet strength.

### Description of Related Art

A deficiency of commercial soft, roll-your-own bait is that the material has a high probability of falling off the hook during casting. Once the commercial material becomes wet, the probability of bait loss increases as water significantly decreases the strength of the material. The person fishing must re-bait, and this re-baiting step reduces fishing time and increases bait consumption. Additionally, the increased loss of bait can exert an adverse environmental impact on streams, rivers, and lakes.

General efforts in this area include those described in U.S. Pat. Nos. 2,246,413; 2,736,981; 4,731,247; 4,826,691; 5,089,277 and 5,827,551 as well as U.S. Patent Application Publication No. 20090047377. Yet, there remains a need in the art for improved fishing baits which overcome these disadvantages.

### SUMMARY OF THE INVENTION

Embodiments of the invention provide compositions and methods for use in commercial and recreational fishing, hunting and trapping. More particularly, embodiments of the invention provide compositions which may serve as a novel fishing bait that is soft, moldable, formable and capable of manipulation into forms attractive to fish (e.g. balls, grubs, worms) that can be applied to a fishing hook, as well as resistant to acceleration forces during casting due to the surprising discovery of increased wet strength. The compositions are moldable, formable, and capable of manipulation at the site of use by the user, for example, capable of being formed about a hook and/or exhibiting a dough-like consistency. The inventors have found through rigorous testing procedures that the novel fish bait compositions stay on the hook both in the dry state and the wet state. The increased wet strength yields several advantages, including minimized loss, increased fishing time, reduced fishing cost, and lowered environmental impact (loss and degradability). Additionally, the compositions provide controlled and extended release of fish attractants. These properties are advantageously achieved through compositions which combine a polymer such as a cellulose ester, a plasticizer, one or more food sources, and optionally one or more fillers. The compositions may include up to 50% attractants, rendering them an effective bait material for attracting fish, crustaceans, and other aquatic creatures.

In embodiments, a composition is provided that comprises at least one cellulose ester, at least one plasticizer, and one or more attractants. The compositions can further comprise one or more fillers, and/or one or more masking agents, and/or one or more preservatives, dyes, pigments, antitacking agents, or texture enhancers, or combinations thereof.

For example, the compositions can comprise by weight 1-30% cellulose ester, 10-70% plasticizer, 0.1-80% attractant, and/or 0-80% filler. Further, for example, the compositions can comprise by weight 1-15% cellulose ester, 15-60% plasticizer, 5-70% attractant, and/or 30-70% filler. In yet further embodiments, the compositions can comprise by weight 11-13% cellulose ester, 20-30% plasticizer, 23-25% attractant, and/or 28-31% filler.

Compositions according to embodiments of the invention can comprise one or more cellulose ester, which can be chosen from cellulose acetate, cellulose acetate propionate, or cellulose acetate butyrate, or combinations thereof, for example. In embodiments, the cellulose ester is cellulose acetate propionate.

According to embodiments the plasticizer of the composition can be triacetin or acetyl triethyl citrate. Further, for example, the plasticizer can be one or more plasticizer chosen from poly(ethylene glycol), poly(ethylene succinate), arabinoxylan acetate, poly(caprolactone), poly(vinyl acetate), poly(N-vinyl pyrrolidone), polyaniline, polyvinyl phenol, poly(acryoyl morpholine), triacetin, triethyl citrate, tributyl citrate, acetyl triethyl citrate, acetyl tributyl citrate, sulfonamides, n-ethyl toluene sulfonamide, dibasic esters, dimethyl adipate or dialkyl esters of carboxylic acids C2-C10, or combinations thereof.

In any embodiment, the compositions can comprise one or more attractants chosen from one or more of shrimp, earthworms, mealworms, fish meal, fish powder, crab meal, squid meal, fish hydrolysate, fish products, fish food, wax worms, anise, garlic, wheat, aquaculture byproducts, marine waste products, corn, sodium chloride, sea salt, Epsom salt, inorganic salts, trace mineral salts, butyric acid, fish oil, crawfish oil, shrimp oil, meat meal products, powdered bone meal, powdered food solids, rhodinyl acetate, dried slaughterhouse waste products, powdered fish, egg, dried milk products, molasses, fish powders, aquaculture by-products, and synthetic spices having a smell similar to that of fish meal, stale fish, shell fish, krill powder, pulverized dried sardine, spray dried inactivated and/or autolyzed yeast, powdered squid, borax, wood flour, bentonite, pulp fibers, and cellulosic materials, dicarboxylic amino acids, glutamic and aspartic acids, betaine, amino acids, glycine, alanine, taurine, tryptamine, and tyramine, or combinations thereof. In embodiments, the one or more attractants can comprise an inorganic salt, and/or a protein, and/or an amino acid, and/or a fatty acid or oil, and/or a cellulosic material, and/or a food source, or combinations thereof.

The compositions can comprise one or more fillers chosen from one or more of corn products, corn flour, corn meal, starches, modified starches, maltodextrin, grain flour, meal, and gelatin, and combinations thereof.

In embodiments, the compositions can be configured to exhibit the following features: when soaked in water for 10 minutes or longer, placed on a hook, and subjected to a casting event of 2 seconds or longer under a centrifugal force of at least about 1 newton, the composition remains on the hook throughout the casting event; and/or when soaked in water for 10 minutes or longer, placed on a hook, and subjected to a casting event of 2 seconds or longer under an angular acceleration of at least about 1500 m/sec², the composition remains on the hook throughout the casting event.

The compositions of the invention can be formulated to exhibit sustained release of the attractant for at least about 10 minutes when submerged in water.

In embodiments, the compositions can be moldable by hand at room temperature.

Also included within the scope of the invention is a fish bait formed from any composition described herein.

Methods of manufacture of a composition are also included within the scope of the invention, for example, a method comprising: mixing a cellulose ester with plasticizer until a soft ball or mass forms, mixing one or more attractants with the cellulose ester and plasticizer, wherein optionally the method is performed at room temperature.

A sculptable and moldable attractant comprising at least one cellulose ester and at least one attractant agent is also an embodiment of the invention. Such sculptable attractants can further comprise at least one plasticizer. Such attractants can comprise a mixture of attractant agents, and/or further comprise at least one filler or a mixture of fillers. In such embodiments, the filler can be chosen from one or more of corn products, corn flour, corn meal, starches, rice, potato, wheat flour, modified starches, maltodextrin, grain flour, meal, and gelatin, and combinations of one of more of these. The attractant may further comprise at least one masking agent, such as one or more masking agent chosen from one or more of garlic, salt, inorganic salt, sugar, and anise, and combinations of one or more of these. In such embodiments, the attractant agent can be chosen from one or more food source, processed fish food, or flavoring, such as a food source or processed fish food or flavoring chosen from one or more of shrimp, earthworms, mealworms, fish meal, fish hydrolysate, fish powder, fish products, fish food, wax worms, anise, garlic, corn, salt, sea salt, Epsom salt, trace mineral salt, inorganic salts, butyric acid, fish oil, crawfish oil, shrimp oil, and meat meal products, and combinations of one or more of these.

In embodiments, the terms attractant, composition, and bait are synonymous and can be used interchangeably. The attractant, composition, or bait can be configured to be capable of withstanding a centripetal force of 0.001 to 3 newtons, and/or capable of withstanding an angular acceleration of 1 to 1500 m/sec², and/or capable of withstanding a simulated casting motion under a force of at least 0.001 newton at least 2 times.

The attractant, composition, or bait can be formulated to provide for controlled release of the attractant agent, and/or provide for extended release of the attractant agent.

Embodiments of the invention also include a composition comprising: at least one cellulose ester chosen from one or more of cellulose acetate, cellulose acetate propionate, or cellulose acetate butyrate, or combinations of one or more of these; at least one plasticizer chosen from triacetin and/or acetyl triethyl citrate; and one or more food source; wherein the composition, when soaked in water for 10 minutes or longer, is capable of remaining on a hook during a casting event subject to a centrifugal force of 0.001 to 2 newtons.

Also included within the scope of the invention is a bait, comprising: a bait composition comprising: at least one cellulose ester, at least one plasticizer, and one or more attractants; and one or more flexible tail comprising a polymer. In such embodiments, or any bait, attractant, or composition of the invention, the flexible tail can be molded with a flexible barb that can be inserted into a soft bait composition. The polymer in such tail can comprise a plastisol formulation. In embodiments, the flexible tail has an expandable serrated end capable of being inserted into the bait composition. Such bait compositions can be provided as a preformed composition, a sculpted composition, or a moldable composition. In embodiments, the flexible tail and the bait composition are disposed on a hook, and/or the flexible tail has at least one end capable of being inserted into the bait composition.

Further embodiments of the invention include a two-part tail configured for insertion into a bait composition, the two-part tail comprising a flexible plastisol tail comprising a base in communication with a barb-type connector and one or more tentacle-like projections extending from the base in a direction opposite the barb-type connector.

### BRIEF DESCRIPTION OF THE DRAWINGS

The accompanying drawings illustrate certain aspects of embodiments of the present invention, and should not be used to limit the invention. Together with the written description the drawings serve to explain certain principles of the invention.

FIGS. 1 and 2 are photographs showing a moldable composition according to an embodiment of the invention.

FIG. 3 is a photograph showing a moldable composition shaped in the form of a ball according to an embodiment of the invention.

FIG. 4 is a photograph showing a moldable composition shaped in the form of a worm according to an embodiment of the invention.

FIG. 5 is a photograph showing a moldable composition shaped in the form of a fish according to an embodiment of the invention.

FIG. 6 is a photograph showing a moldable composition shaped in the form of a crawfish according to an embodiment of the invention.

FIG. 7 is a photograph of a casting simulation setup.

FIG. 8 is a graph showing the results of simulated casting with dry bait for the TA compositions and the PowerBait®.

FIG. 9 is a graph showing repeat cast/soak data for high plasticizer triacetin (TA) compositions.

FIG. 10 is a graph showing the release profile of TA-67.

FIG. 11 is a graph showing the release profile of TA-68.

FIG. 12 is a graph comparing the initial release profiles of TA-67 and TA-68.

FIG. 13 is a graph comparing the reformed release profiles of TA-67 and TA-68.

FIG. 14 is a graph showing the results of simulated casting with wet bait for the TA compositions and the PowerBait®.

FIG. 15 is a photograph showing a variety of flexible tails applied to a fishing hook according to an embodiment of the invention.

FIG. 16 is a photograph showing the soft flexible tails of FIG. 15 applied to a fishing hook with the moldable compositions according to an embodiment of the invention.

FIG. 17 is a photograph showing soft flexible tails molded to a collapsible barb according to an embodiment of the invention.

FIGS. 18A and 18B are photographs showing the soft flexible tails of FIG. 17 attached to the moldable compositions according to an embodiment of the invention.

### DETAILED DESCRIPTION OF VARIOUS EMBODIMENTS OF THE INVENTION

Reference will now be made in detail to various exemplary embodiments of the invention. It is to be understood that the following discussion of exemplary embodiments is not intended as a limitation on the invention. Rather, the following discussion is provided to give the reader a more detailed understanding of certain aspects and features of the invention.

As used herein, the terms “composition”, “fish putty”, “fish bait”, and “attractant” are used interchangeably. Embodiments of the invention provide sculptable and moldable compositions which include a combination of a cellulose ester, a plasticizer, one or more attractant agents, and optionally one or more fillers, which compositions may be useful as bait for fish or other water creatures. The cellulose ester may include, but is not limited to, cellulose acetate (CA), cellulose acetate propionate (CAP), and cellulose acetate butyrate (CAB) and their derivatives. Cellulose esters are commercially available from Eastman Chemical Company (Kingsport, Tenn.; see http://www.eastman.com/Brands/Eastman Cellulose Esters/Pages/Overview.aspx and linked literature). Additionally, this invention contemplates the use of more than one cellulose ester such that any combination of cellulose esters may be used.

As stated above, the moldable compositions may further comprise an effective amount of a plasticizer to plasticize the cellulose ester(s). When plasticized, the cellulose ester(s) provide structural strength and integrity for the bait. Non-limiting examples of plasticizers that may be useful include poly(ethylene glycol) (PEG 300 up to PEG 2000), poly(ethylene succinate), arabinoxylan acetate, poly(caprolactone), poly(vinyl acetate), poly(N-vinyl pyrrolidone), polyaniline, polyvinyl phenol, poly(acryoyl morpholine), triacetin, triethyl citrate, tributyl citrate, acetyl triethyl citrate, acetyl tributyl citrate, sulfonamides, n-ethyl toluene sulfonamide, dibasic esters, dimethyl adipate, dialkyl esters of carboxylic acids C2-C10, and other plasticizers for cellulose esters known in the art . Additional examples may be found in the scientific literature (for example, see Congyu Bao. Cellulose acetate/plasticizer systems: structure, morphology and dynamics. Polymers. Universite Claude Bernard-Lyon I, 2015. English. <NNT: 2015LYO10049> <tel-01186696>). Further, more than one plasticizer may be employed such that any combination may be used.

In embodiments, the attractant agent(s) may be a food source, such as shrimp, crab, crab meal, animal protein hydrolysate, earthworms, mealworms, fish meal, fish hydrolysate, fish products, fish food, wax worms, anise, garlic, corn, sodium chloride, sea salt, Epsom salt (magnesium sulfate), inorganic salts, butyric acid, fish oil, crawfish oil, shrimp oil, aquaculture by-products, and meat meal products. Additional non-limiting examples of attractant agents that may be used include powdered bone meal, powdered food solids, rhodinyl acetate, dried slaughterhouse waste products, essential oils, powdered fish, egg, dried milk products, molasses, cheese, fish powders and synthetic spices having a smell similar to that of fish meal, stale fish, shellfish, hill powder, pulverized dried sardine, spray dried inactivated and/or autolyzed yeast, powdered squid, small peptides ranging from 2-20 amino acids, dicarboxylic amino acids and other amino acids, such as glutamic and aspartic acids, betaine, glycine, alanine, taurine, tryptamine, and tyramine. The attractants may be a pre-produced fish food containing fish meal and optionally fish powder, with grain filler. Thus, the attractant agent(s) may be represented as a variety of different substances, including but not limited to inorganic salts, proteins, amino acids, small peptides ranging from 2-20 amino acids, fatty acids, oils, and cellulosic materials. Olfactory stimuli in fish have been reviewed (see Hara, T. J. (1994), Olfaction and gustation in fish: an overview. Acta Physiologica Scandinavica, 152: 207-217. doi: 10.1111/j.1748-1716.1994.tb09800.x). Additionally, the attractants may include visual attractants such as glitter, colors, or dyes. The attractant agent(s) may be provided in pulverized, ground, and/or powdered form to facilitate mixing into the composition. Exemplary compositions of the invention are described in detail in the Examples.

Additionally, the moldable bait may optionally further comprise a filler or mixture of fillers non-limiting examples of which include corn products, corn flour, corn meal, starches, modified starches, maltodextrin, grain flour, meal, or gelatin. The purpose of the filler is to provide bulk to the composition, enhance texture, and facilitate mixing into a homogenous product. Some fillers of the composition may also serve a dual role as both filler and an additional food source and attractant agent, for example, for fish.

Additionally, the moldable bait may further comprise a masking agent non-limiting examples of which include garlic, salt, inorganic salt, anise. As used herein, a “masking agent” is a substance which emits an odor or scent which masks scents on the bait composition which are repulsive to fish which may be picked up during application of the bait to the hook. These negative scents are generally attributed to substances on the hands of the person applying the bait, which may include natural compounds such as the amino acid serine, as well as artificial substances such as gasoline, etc. For a general discussion of the difference between masking agents and attractants, see “Fatal Attractants”, by Gary Garth, Field and Stream Online, January 2003. However, as is recognized in the art, some substances may serve as both attractants and masking agents. Additionally, more than one masking agent may be used.

Additional components of the moldable bait may include one or more preservatives, dyes, pigments, antitacking agents, and texture enhancers. These will generally be present in the composition at a concentration less than 10% by weight, and preferably less than 5% by weight.

Compositions for the moldable bait can include cellulose ester, plasticizer, and attractant, and optionally filler. Any combination of cellulose ester, plasticizer, attractant, and filler can be used. Compositions can comprise cellulose ester, plasticizer, and attractant, and optionally filler with an amount of cellulose ester in the range of 1-99% (concentration by weight), such as from 2-80%, or from 3-75%, or from 5-65%, or from 7-60%, or from 10-55%, or from 25-50%, or from 30-45%, or from 20-35%. A preferred concentration of cellulose ester is 1-15%. Compositions can comprise cellulose ester, plasticizer, and attractant, and optionally filler with an amount of plasticizer (concentration by weight) in the range of 1-99%, such as from 5-95%, or from 10-85%, or from 15-80%, or from 20-75%, or from 22-65%, or from 25-55%, or from 28-45%, or from 30-40%, or from 15-60%. A preferred concentration of plasticizer is 35% or less. Compositions can comprise cellulose ester, plasticizer, and attractant, and optionally filler with an amount of attractant (concentration by weight) in the range of from 1-99%, such as from 2-98%, or from 5-95%, or from 10-90%, or from 15-85%, or from 20-80%, or from 25-75%, or from 30-70%, or from 35-65%, or from 40-60%, or from 45-55%, such as about 50%. A preferred concentration of attractant is 5-70%. Compositions can comprise cellulose ester, plasticizer, and attractant, and optionally filler with an amount of filler (concentration by weight) in the range of 0-99%, such as from 0-5%, or from 0.1-8%, or from 0.2-10%, or from 0.3-6%, or from 0.4-7%, or from 0.5-5%, or from 0.6-1.2%, or from 0.8-1.5%, or from 2-10%, or from 5-15%, or from 3-20%, or from 6-25% and so on. A preferred concentration of filler is 30-70%.

Exemplary compositions for the moldable bait include (concentration by weight) up to about 30% cellulose ester, about 10-70% plasticizer, about 0.1-75% attractant, and about 0-80% filler. The compositions for the moldable bait can include about 5-20% cellulose ester, about 15-40% plasticizer, about 1-80% attractant, and about 20-60% filler. Other compositions for the moldable bait can include about 11-15% cellulose ester, about 20-30% plasticizer, about 23-25% attractant, and about 10-30% filler. Other exemplary compositions include about 5-25% cellulose ester, about 15-45% plasticizer, about 50-85% attractant, and about 0-15% filler. Even further exemplary compositions can include from about 7-16% cellulose ester, about 18-32% plasticizer, about 45-95% attractant, and about 0-25% filler. Other compositions can comprise from about 2-25% cellulose ester, about 20-35% plasticizer, about 40-70% attractant, and about 0-25% filler. Any of these amounts of components can be used in any of the formulations in any combination.

In embodiments, the moldable bait is formulated so that it is able to withstand various forces associated with casting such that it maintains form without significantly degrading, either in dried or wet form (e.g. after submersion in water). This is due to in part to the inventors' unexpected discovery of maintained wet strength such that the composition remains fixed on a fishing hook without falling off during repeated casting forces when wet. Various forces associated with casting include centrifugal forces and angular acceleration. Example 2 describes rigorous testing procedures carried out by the inventors which demonstrate the ability of embodiments of the inventive compositions to withstand casting forces in either wet or dried form.

In embodiments, the moldable bait is able to withstand a centrifugal force of at least about 0.001 to 0.01 newton, at least about 0.001 to 0.005 newton, at least about 0.005 to 0.01 newton, at least about 0.01 to 0.1 newton, at least about 0.01 to 0.05 newton, at least about 0.05 to 0.1 newton, least about 0.1 to 0.5 newton, at least about 0.5 to 1.0 newton, at least about 1.0 newton to 1.5 newtons, at least about 1.0 newton to 2.0 newtons, preferably at least about 1.5 newtons, more preferably at least about 1.6 newtons, even more preferably at least about 1.7 newtons, and most preferably at least about 1.8 newtons or higher, such as up to 2 or 3 newtons and higher, in dried or wet form, or higher. In embodiments, the bait is able to withstand a centrifugal force of less than 3 newtons, or less than 2 newtons, or less than 1 newton.

Embodiments of the invention provide a moldable bait composition capable of withstanding an angular acceleration of at least about 1 m/ sec² to 10 m/sec², at least about 10 to 100 m/sec², a least about 100 to 500 m/sec², at least about 500 to 1000 m/sec², at least about 1000 to 1500 m/sec², preferably at least about 1600 m/sec², even more preferably at least about 1700 m/sec², and most preferably at least about 1800 m/sec² or higher, such as up to 2000 m/sec² and higher, in dried or wet form, or higher. In embodiments, the bait is capable of withstanding an angular acceleration of less than 1500 m/sec².

Additional embodiments of the invention provide a moldable bait composition able to withstand a simulated casting force/motion of at least about 0.001 to 0.01 newton, at least about 0.001 to 0.005 newton, at least about 0.005 to 0.01 newton, at least about 0.01 to 0.1 newton, at least about 0.01 to 0.05 newton, at least about 0.05 to 0.1 newton, least about 0.1 to 0.5 newton, at least about 0.5 to 1.0 newton, at least about 1.0 newton to 1.5 newtons, at least about 1.0 newton to 2.0 newtons, preferably at least about 1.5 newtons, more preferably at least about 1.6 newtons, even more preferably at least about 1.7 newtons, and most preferably at least about 1.8 newtons force, or higher, at least about 2 times, preferably at least about 5 times, even more preferably at least about 10 times, still more preferably at least about 15 times, still more preferably at least about 20 times, still more preferably at least about 30 times, still more preferably at least about 40 times still more preferably at least about 50 times, still more preferably at least about 70 times, still more preferably at least about 70 times, still more preferably at least about 80 times, and most preferably at least about 100 times, in dried or wet form. In embodiments, the bait is capable of withstanding a simulated casting force/motion of less than 3 newtons, or less than 2 newtons, or less than 1 newton.

Additional embodiments of the invention provide a moldable bait composition capable of controlled and/or extended release of any attractant agent described herein when submerged in water, such as sustained release for at least about 30 seconds, preferably at least about 1 minute, even more preferably at least about 2 minutes, still more preferably at least about 5 minutes, still more preferably at least about 10 minutes, still more preferably at least about 15 minutes, still more preferably at least about 30 minutes, still more preferably at least about 45 minutes, and most preferably at least about 1 hour or longer. Conceivably, embodiments of the invention may include compositions capable of sustained release on the order of hours, such as at least about 1, 2, 4, 6, 8, 10, 12, 14, 15, 18, or 20 hours or more, or even days, for certain applications requiring long-term release, such as commercial fishing or baiting of traps for catching shellfish. Example 3 provides detailed data which demonstrates controlled, sustained release of embodiments of the inventive compositions which include sodium chloride as an attractant agent.

The moldable bait compositions, in embodiments, may be generally prepared at room temperature by first mixing the cellulose ester with plasticizer until a soft ball or mass forms, then adding filler and mixing until preferably homogenous, and finally adding one or more attractant agents and then again mixing until preferably homogenous. Additionally, water may be added to facilitate mixing. The mixing may be achieved through equipment such as a mortar and pestle, blender, or industrial mixer, or with hands. An example of a detailed procedure for preparing an embodiment of the inventive fish bait compositions is provided in Example 4. As mixing is performed at room temperature, the preparation methods advantageously do not degrade or denature fish attractant components that are vulnerable to heating, such as proteins and amino acids.

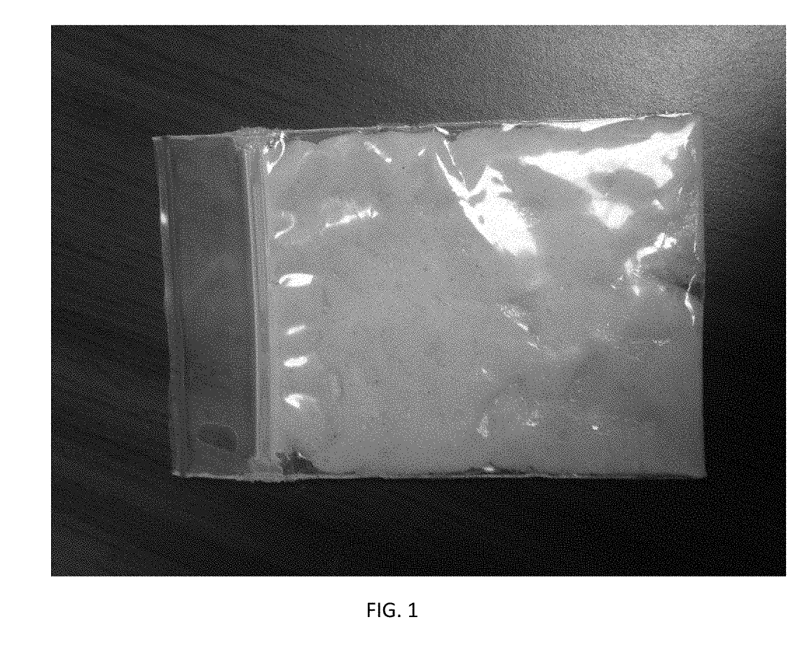

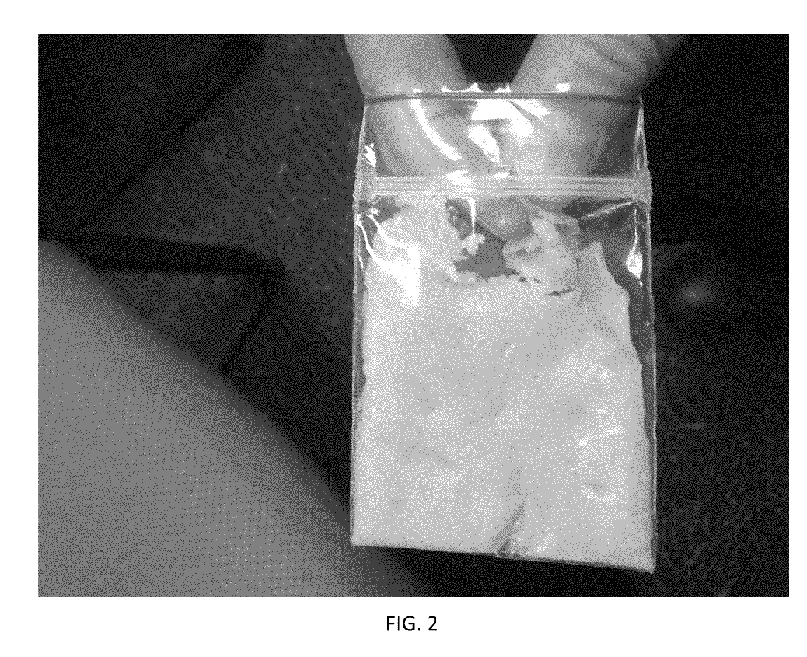

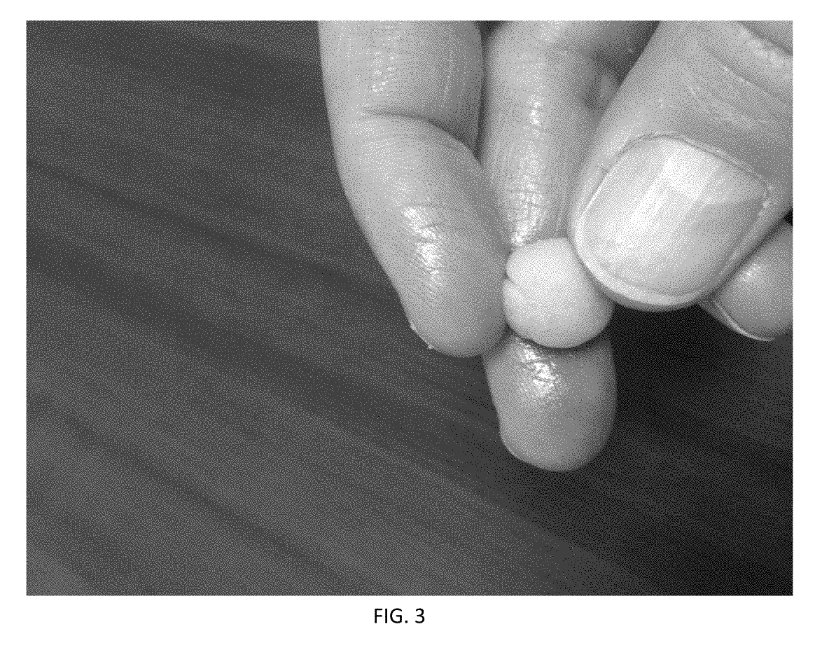

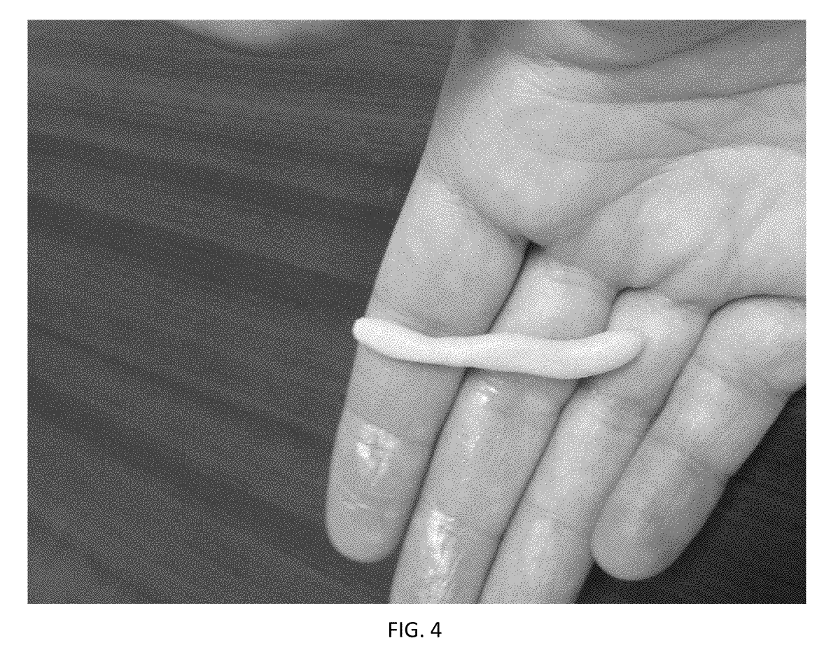

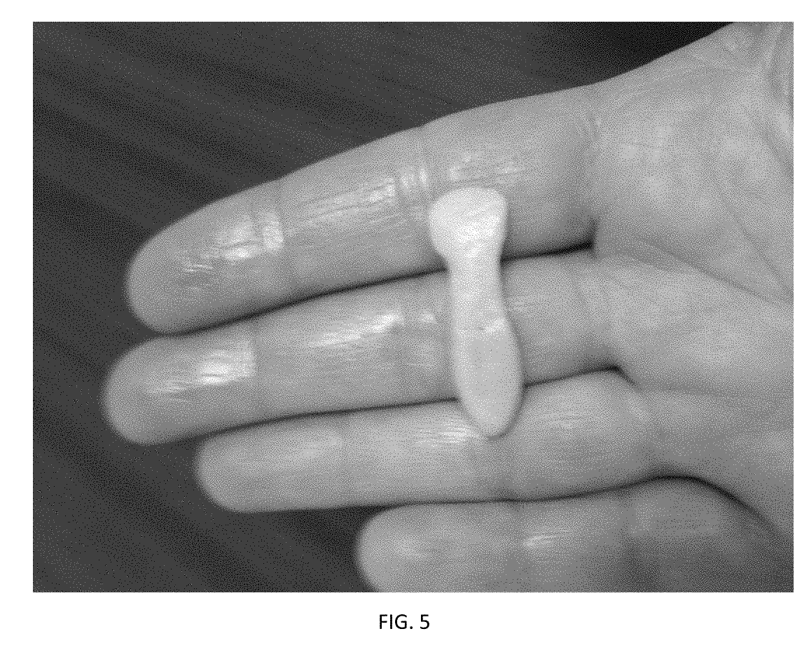

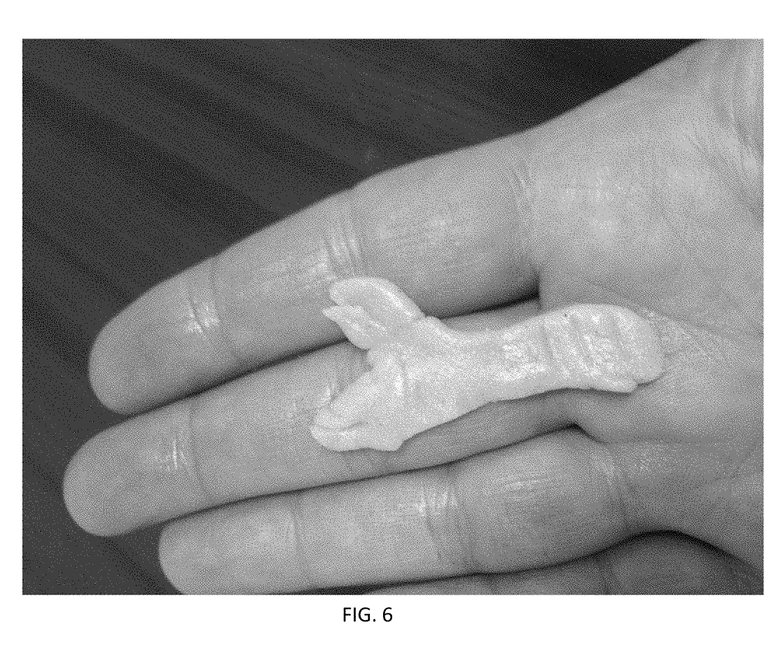

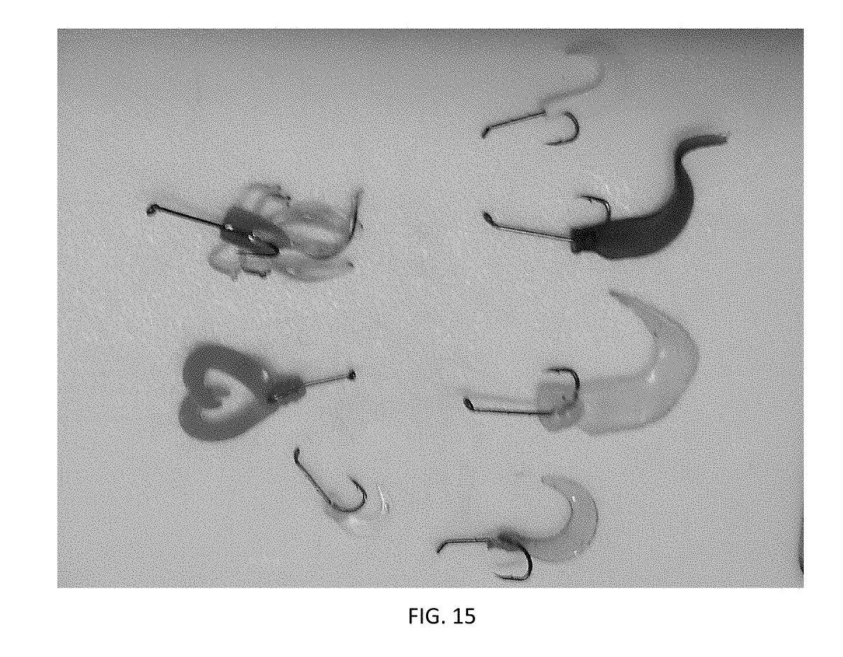

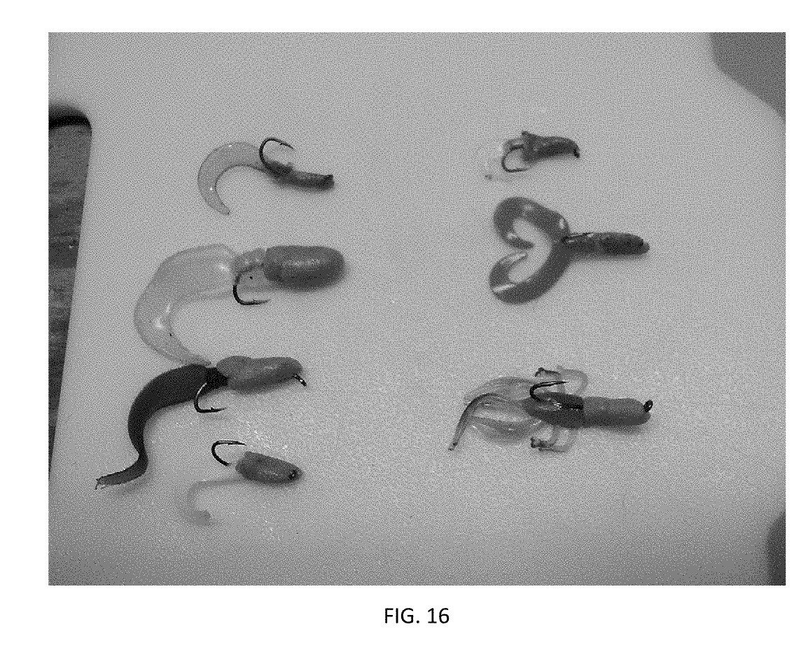

The moldable bait compositions may be packaged and stored in plastic bags or containers as a putty (or dough-like consistency), an example of which is shown in FIG. 1 and FIG. 2. As the moldable compositions are both pliable at ambient temperature and durable when wet, they may be manipulated in the field at the site of use by the user into a variety of forms attractive to fish, including eggs, grubs, worms, minnows, shads, shrimps, mullets, crawlers, and the like, and baited on conventional fishing hooks or used as bait in traps or cages. However, the compositions are not limited to these forms and may conceivably be sculpted into any form that might visually be attractive to fish and other aquatic creatures. FIGS. 3-6 show examples such as a ball (FIG. 3), worm (FIG. 4), fish (FIG. 5), and crawfish (FIG. 6). Example 1 below demonstrates the success of using worm shapes in attracting fish. The moldable bait compositions may be combined with other lures to increase their attractiveness to fish due to the ability of the compositions to sustain release fish attractant agents. For example, a soft flexible tail made from a plastisol formulation can be inserted into the bait composition to produce a bait that provides odor and taste attractants with a visual attracting form. The tail may be inserted into preformed baits which may or may not be moldable. Alternatively, the tail may be applied directly to a fishing hook as shown in FIG. 15, and the moldable bait compositions may also be applied to the hooks as shown in FIG. 16. In the embodiment shown in FIG. 16, the tail is applied to the throat portion of the hook just above the bend or only extending into a portion of the bend, leaving most of the bend exposed and the entire bite portion exposed, while the moldable bait compositions are applied to the shank of the hook (between the throat and the eye). However, alternative arrangements of tail and moldable bait on the hook are possible. The compositions (with or without tails) can be applied to any sized fishing hook at any portion of the hook, as long as the bite portion remains exposed, either by molding the composition or tail around the hook and/or by penetrating the formed composition or tail with the point of the hook like a live bait.

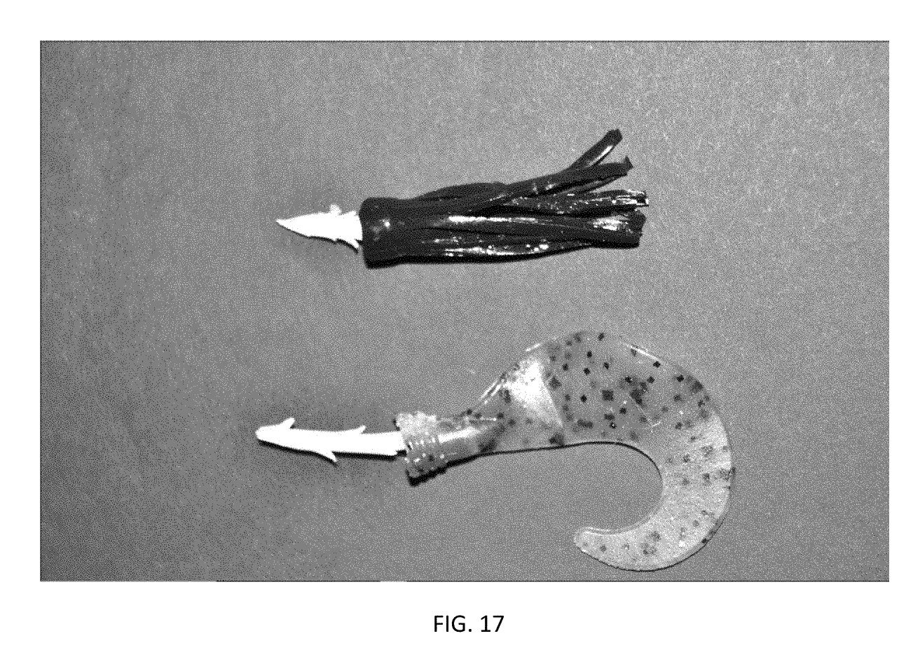

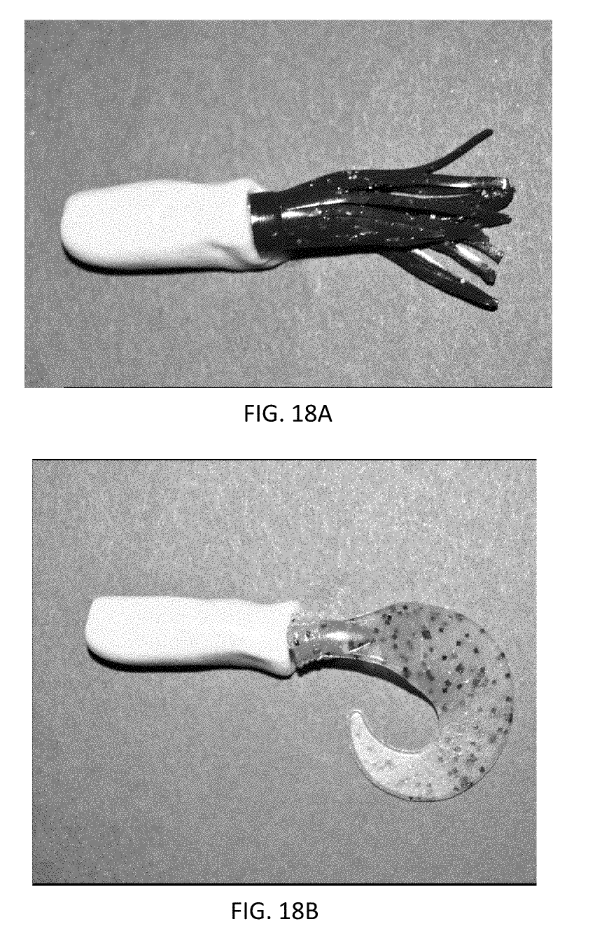

FIGS. 17, 18A and 18B show a soft flexible tail prepared with plastisol. The tail can be molded with an expandable barb that can be inserted into a fish putty body or any other soft body including traditional soft baits. The barb can comprise the same or different composition as the tail. In embodiments, the barb comprises plastic and is in communication with one end of the tail. For example, the barb can be inserted into the base of the tail and one or more tentacle-like projections can extend from the base in a direction opposite the barb. Embodiments include a two-part tail configured for insertion into a bait composition, the two-part tail comprising a flexible plastisol tail comprising a base in communication with a barb-type connector and one or more tentacle-like projections extending from the base in a direction opposite the barb-type connector. Like a wall molly in drywall, the flexible barb increases the strength of the composite bait due to expansion such that greater force is required to remove the soft bait composition, and thus allows the soft bait to withstand repeated casting forces without falling off. Any combination of tails can be used with any shape fish putty bait to match desired color combinations. The two-part (composite) bait provides a bait that addresses olfactory, gustatory and visual triggers of fish.

Thus, one embodiment of the invention provides a two-part bait which includes a bait composition and a flexible tail. The bait composition includes a cellulose ester, a plasticizer, and one or more attractants; and the flexible tail includes a polymer such as a plastisol formulation. The flexible tail has at least one end capable of being inserted into the bait composition, which can be a molded flexible barb such as an expandable serrated end that can be inserted into a soft bait composition. The bait composition can be provided as a preformed composition, a sculpted composition, or a moldable composition. In some embodiments, the flexible bait and/or tail is disposed on a hook.

The following Examples serve to further illustrate various facets of the invention and should not be construed to limit the scope of the invention.

### EXAMPLE 1

### Field Trials, Compositions TA-100, TA-101, TA-102, TA-103

Summary

Field trials were conduction at the Pembroke, Virginia Wildlife boat launch area. This boat launch is located on the New River. The objective was to test Fish Putty compositions TA-100, TA-101, TA-102, and TA-103 to determine if native wild fish would strike and eat the bait. The New River water was clear so small fish were easy to see. The fish size ranged from fingerlings (2-3 inches) to approximately 5-6 inches. Rock bass (red eyes) and small mouth bass were present.

Conditions

Time—5:15 pm to 6:15 pm.

Approximately 70° F., cloudy, not raining during trial but had rain earlier.

New River water was clear, river height normal and slow moving.

Observations

Fish were visually identified in the New River, including small mouth and rock bass (red eyes).

Testing was done at the bridge footings and from the bank in front of the R & R Campground.

Shape—Fish Putty was rolled in small balls (diameter of about ⅛-¼ inch) and small worm shapes (about ⅛ inch diameter and a length of about ½-1 inch). The fish consistently struck the worm shape and ignored the ball shape. This observation was consistent with all Fish Putty compositions.

The Fish Putty was tossed into the river once it was shaped (within 10-15 ft. of the shore). The composition sank slowly, easy to see while sinking and visible on the river bottom. The water depth ranged from about 2-4 feet. The worm shape oscillated as it sank. This motion may contribute to strike rate.

Strike count—Approximately 75-80% strike rate with worm shaped Fishy Putty. 5% or less strike rate with ball shaped Fish Putty.

Bare hands were used to handle and roll the Fish Putty compositions. The high strike count implies that any human scent on the bait did not deter the fish.

2-3″ Small fish—These fish struck the worm shape but spit it out more often than eating the bait.

5-6″ Rock Bass—Aggressively struck all compositions shaped like worms. The water was sufficiently clear to see the rock bass chew the bait, spit it out and re-ingest the bait. One rock bass ate 10-15 “worms” before leaving. This fish ate the compositions with no observed dislikes or unusual behavior.

Fish Putty colors—No colors or dyes were added to the compositions. The attractant compositions were light brown/yellow.

No real drawbacks identified. All compositions were easy to shape and held together as designed. Composition TA-103 seemed to stick to fingers which made throwing the bait awkward. Wetting the fingers in the river solved this issue. Dusting Composition TA-103 with corn flour is another option to reduce any sticking.

TABLE I
Composition TA-100

| Composition TA-100 | Weight - grams | Percentage |
|---|---|---|
| Cellulose Ester | 2 | 11.4 |
| Plasticizer | 5 | 28.6 |
| Filler/Attractant | 5 | 28.6 |
| Attractant | 4 | 22.9 |
| Water | 1.5 | 8.6 |
| Total | 17.5 | |

TABLE II
Composition TA-101

| Composition TA-101 | Weight - grams | Percentage |
|---|---|---|
| Cellulose Ester | 2 | 12.1 |
| Plasticizer | 4 | 24.2 |
| Filler/Attractant | 5 | 30.3 |
| Attractant | 4 | 24.2 |
| Water | 1.5 | 9.1 |
| Total | 16.5 | |

TABLE III
Composition TA-102

| Composition TA-102 | Weight - grams | Percentage |
|---|---|---|
| Cellulose Ester | 2 | 12.5 |
| Plasticizer | 3.5 | 21.9 |
| Filler/Attractant | 5 | 31.3 |
| Attractant | 4 | 25 |
| Water | 1.5 | 9.4 |
| Total | 16 | |

TABLE IV
Composition TA-103

| Composition TA-103 | Weight - grams | Percentage |
|---|---|---|
| Cellulose Ester | 2 | 12.1 |
| Plasticizer | 5 | 30.3 |
| Filler/Attractant | 5 | 30.3 |
| Attractant | 4 | 24.2 |
| Water | 0.5 | 3 |
| Total | 16.5 | |

### EXAMPLE 2

### Simulated Casting—Fish Putty Compositions vs. Commercial PowerBait®

Experimental

Simulated casting experiments were conducted to demonstrate the improved strength of the cellulose esters compositions. These compositions were compared with two Berkley PowerBait® compositions.

TABLE V
Composition Soft Bait

| Commercial Soft Bait | Manufacturer |
|---|---|
| PowerBait ® Turbo Dough 42% Stronger, Yellow | Berkley |
| PowerBait ® Extra Scent ™, Glitter, Spring Green, | Berkley |
| Trout Bait | |

Equipment:

US Bench top electronic balance

Berkley Dough Bait Mold—Small ball former used

Shimpo DT-205B non-contact digital tachometer

Monster Guts: Pulse width modulation (PWM) 12 volt motor speed control and 12 volt DC, 5A power supply (monsterguts.com)

Sullivan12 volt DC motor modified to spin hooks for simulated casting.

Hook—Eagle Claw #3 hook, 2.5 cm long

TABLE VI
Formulations Plasticized with Triacetin: TA-104 and TA-105

| Compositions with Triacetin | TA-104 Grams | TA-105 Grams |
|---|---|---|
| Cellulose Ester | 2 | 2 |
| Plasticizer | 3 | 5 |
| Filler/Attractant | 9 | 9 |
| Weight of 10 formed balls | 9.7 | 8.6 |
| Average Ball Weight | 0.97 | 0.86 |

TABLE VII
Formulations Plasticized with ATEC: TA-106 and TA-107

| Compositions with Acetyl Triethyl | | |
|---|---|---|
| Citrate (ATEC) | TA-106 Grams | TA-107 Grams |
| Cellulose Ester | 2 | 2 |
| Plasticizer | 3 | 5 |
| Filler/Attractant | 9 | 9 |
| Weigh of 10 formed balls | 8.9 | 8.9 |
| Average Ball Weight | 0.89 | 0.89 |

TABLE VIII
Commercial Bait

| | Weight of 10 Balls - | Average Ball |
|---|---|---|
| Commercial Bait | Grams | Weight |
| Berkley 42% Turbo Bait | 5.6 | 0.56 |
| Berkley Spring Green | 5.6 | 0.56 |

Casting Set-up:

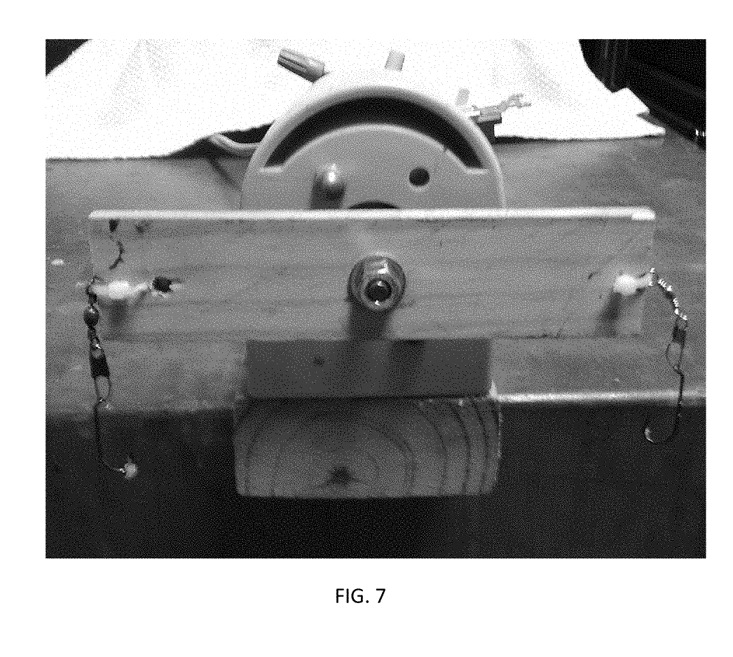

A flat wooden slat was cut, drilled and attached to the Sullivan motor shaft. Wire ties were used to attach the hook and swivel to each end of the wooden arm. This set-up (shown in FIG. 7) allows for two balls to be tested simultaneously. The motor is turned on for 2 seconds and the balls rotate in a circle. The rotation motion creates an outward force on the ball. The circle radius is 13.5 cm. Rotational forces can be readily calculated using online tools like CalcTool: Centrifugal Force (www.calctool.org/CALC/phys/newtonian/centrifugal).

The Shimpo DT-205B tachometer display updates once per second. Therefore 2 seconds was the shortest time interval to obtain a speed (rpm) reading. (1 second to read, 1 second to update the display). The 12 volt motor was set to 1500 rpm with the speed controller under continuous run condition. Next the rpm was measured 10 times for the 2 second cast simulation (on/off). The average rpm was used in the CalcTool Centrifugal Force calculator. Table IX summarizes the results.

TABLE IX
Test Number and RPM

| Test Number | RPM |
|---|---|
| 1 | 1088 |
| 2 | 1116 |
| 3 | 1229 |
| 4 | 1097 |
| 5 | 1066 |
| 6 | 1138 |
| 7 | 1077 |
| 8 | 1093 |
| 9 | 1093 |
| 10 | 1092 |
| Average | 1108.9 |
| Standard Deviation | 46.6 |
| Coefficient of Variance % | 4.2 |

Dry Cast Experiments. The dry casting experiments were designed to test the number of simulated cast needed to cause the bait(s) to come off the hook. The experiment was stopped when 1 ball came off the hook. This failure mode was easily detected with an audible noise as the ball impacted the plastic shroud surrounding the rotating arm (safety cover). Additionally the experiment was stopped if the cumulative cast number equaled 100.

Composition TA-104 and TA-105 used triacetin as the plasticizer. The TA 104 composition has a low plasticizer concentration and the TA 105 has a high plasticizer concentration. Increased plasticizer concentration makes the final bait softer and reduces the matrix cohesion.

Composition TA-106 and TA-107 used ATEC as the plasticizer. The TA 106 composition has a low plasticizer concentration and the TA 107 has a high plasticizer concentration. Increased plasticizer concentration makes the final bait softer and reduces the matrix cohesion. This design allows one to compare the impact of plasticizer concentration and plasticizer type on simulated casting.

TABLE X
Plasticizer Content of Compositions

| Plasticizer | Low Concentration | High Concentration |
|---|---|---|
| Triacetin | TA-104 | TA-105 |
| ATEC | TA-106 | TA-107 |

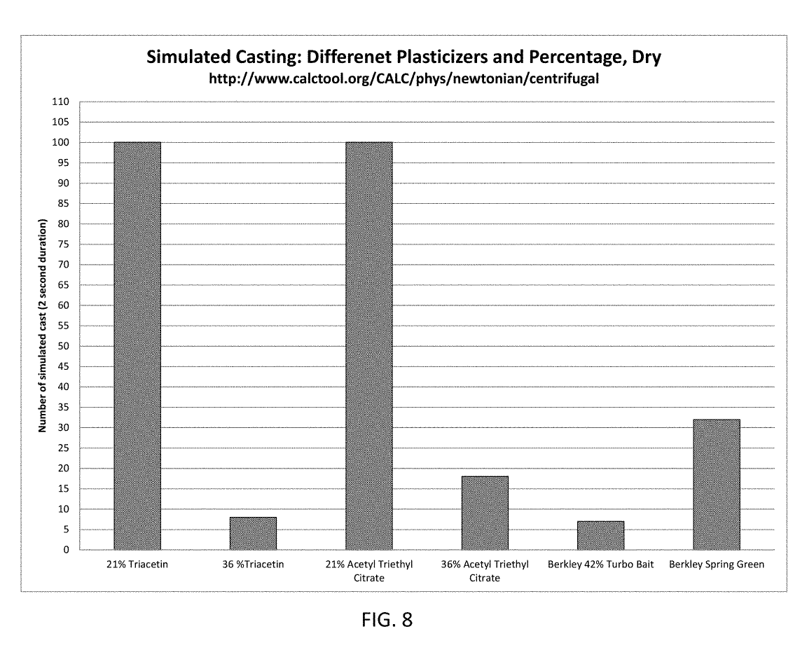

Table XI and FIG. 8 summarize the dry cast data for the TA compositions and the PowerBait®.

TABLE XI
Dry Cast Data

| | Ball | | Centrifugal | Centrifugal |
|---|---|---|---|---|
| | Weight | Number of | acceleration | force |
| Composition | grams | Casts | (m/sec²) | (newtons) |
| TA-104 | 0.97 | 100 (no failure) | 1821 | 1.77 |
| TA-105 | 0.86 | 8 | 1821 | 1.57 |
| TA-106 | 0.89 | 100 (no failure) | 1821 | 1.62 |
| TA-107 | 0.89 | 18 | 1821 | 1.62 |
| Berkley 42% | 0.56 | 7 | 1821 | 1.02 |
| Turbo Bait | | | | |
| Berkley | 0.56 | 32 | 1821 | 1.02 |
| Spring Green | | | | |

The data shows that the low plasticized compositions do not come off the hook after 100 repeated 2 second casts. This demonstrated that plasticizer concentration can be adjusted to improve the matrix cohesion and stiffness to withstand casting forces. Plasticizer should range from 15% to 60% based on total weight.

Wet Cast Experiment. The wet cast experiment simulates what a fisherman does when fishing. The objective is to demonstrate the wet strength of the bait. Once the hook is baited, the dry bait is casted into the water. The bait is allowed to sit, slowly retrieved and re-casted. To simulate this repetitive action the following is done:

Bait is placed on the hook of the simulated caster. A single cast is performed with the bait dry. This simulates the initial cast into the water. The bait is placed in a cup with 60 mL of tap water for 5 minutes. The bait remains on the hook. After a 5 minute soak in the water, 2-second casts are performed until the bait fails (comes off the hook). The casting motion is repeated until the bait no longer remains on the hook (failure). The ball is then recovered, re-formed and placed back on the hook, and soaked in water. One cast is done to simulate the re-casting into the water again and the procedure repeated, followed by the next 5 minute water soak. After 5 minutes, the 2-second casts are repeated until the bait fails. This process repeats until the number of casts to failure drops below the prior test cycle. Again, the objective is to demonstrate the bait wet strength as the accumulated water exposure time increases.

The Berkley products were too soft and slippery to reform after the first 5 minute soak. No additional soaking testing was done with these products.

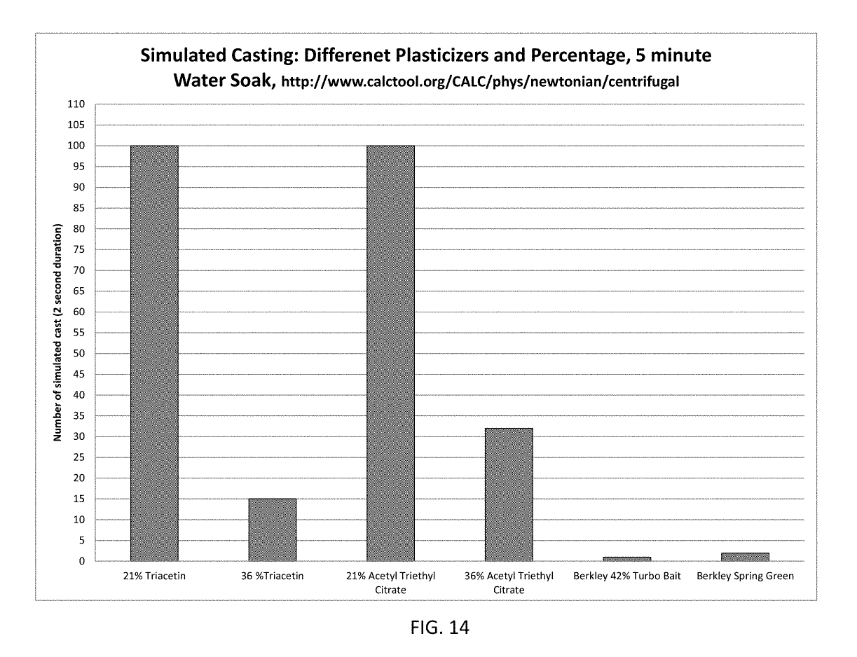

Set 3 and 4 are repeated until the bait comes off the hook. Failure mode. Table XII and FIG. 14 show the results of the simulated casting with wet bait for the TA compositions and the PowerBait®.

TABLE XII
Wet Cast Data

| | | Number of | Number of | Number of |
|---|---|---|---|---|
| | Number of | casts to | casts to | casts to |
| | casts to | failure, | failure, | failure, |
| | failure, | 5 minute | 5 minute | 5 minute |
| | 5 minute | soak (10 | soak (15 | soak (20 |
| Composition | soak | min. total) | min. total) | min. total) |
| TA-104 | 100 (no failure) | Not tested due | | |
| | | to no loss | | |
| | | in strength | | |
| TA-105 | 15 | 18 | 32 | 14 |
| TA-106 | 100 (no failure) | Not tested due | | |
| | | to no loss | | |
| | | in strength | | |
| TA-107 | 32 | 39 | 11 | |
| Berkley 42% | 1 | Could not recover | | |
| Turbo Bait | | and reform | | |
| Berkley | 2 | Could not recover | | |
| Spring Green | | and reform | | |

The force (newtons) was not calculated once the baits became wet. It is anticipated that the baits increased in weight as water is absorbed. The force would increase in proportion to the weight increase at a constant rpm. At a minimum, the baits would have experienced the force listed in Table XI.

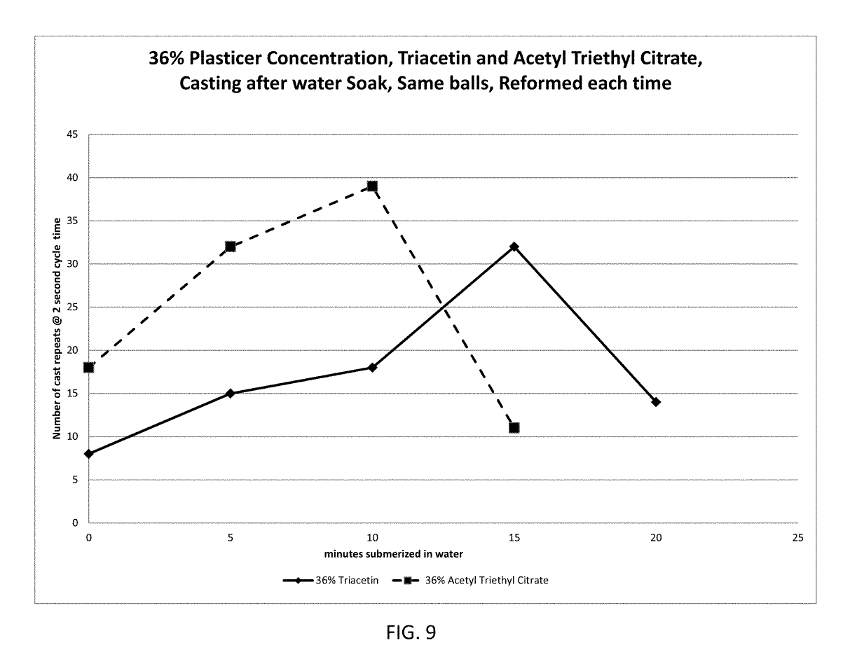

As shown in Table XII and FIG. 14, the Berkley products fail within the first or second cast. This observation shows the material has less structural cohesion/integrity compared to the TA compositions when wet. FIG. 9 shows the repeat cast/soak data for the high plasticizer TA compositions. The data shows the structural cohesion/integrity improves with subsequent 5 minute water soaks. At 15 minutes and 10 minutes total soak time the upward trend stops for the TA-104 and TA-105 composition respectively. However, both compositions exceed the commercial product casting performance even at long soak times.

The unexpected performance increase can be contributed to the slow leaching of the plasticizer by the water causing the composition to become stiffer. The dry and wet casting results show the improved strength at low plasticizer concentrations (TA-104 & TA-106). Mass transfer limits the leaching rate so the TA composition remains re-formable though the 15 and 20 minute water contact. These compositions increase the usable fishing time since the bait does not come off once it becomes wet.

### EXAMPLE 3

### Sustained Release and Regenerated Sustained Release of Attractant

Summary

Sodium chloride or common table salt is an additive or treatment for fishing baits. Todd Kuhn's online article, “Bass Tips: Why and How You Should be Fishing Salted Baits” (see Kuhn, Todd, Bass Tips: Why and How You Should be Fishing Salted Baits, Outdoor Life, Jul. 10, 2015, http ://www .outdoorlife.com/blog s/gone-fishin%E2% 80% 99/bass-tips-why-and-how-you-should-be-fishing-salted-baits) is one example supporting the use of salt. Salt and other bait attractants can readily be blended into the inventive Fish Putty Composition. These attractants include but are not limited to; fish oil, crawdad oil, mealworms, shrimp fluff, cheese, molasses, anise, garlic.

Fish Putty with added salt offers a convenient means to demonstrate sustained release and regenerated sustained release using a conductivity meter. The objective of this work is twofold:

1. Measure the release profile of low and high salt formulations which have been rolled into a ball.

a. Demonstrates the initial release profile of a freshly formed bait

b. Release profile is controlled by mass transfer. Water must diffuse into the matrix, dissolve the salt and migrate out into the bulk water.

2. Measure the release profile of balls recovered from step 1 which has been reformed.

a. Demonstrates that used salted bait can be reformed and the release is rejuvenated.

b. Reforming the ball, remixes the compositions and salt is moved from the interior towards and on the exterior of the ball. This action rejuvenates the bait release profile and extends the fishing time. Again the release profile is mass transfer controlled.

Experimental:

Two compositions were prepared. TA 67 contained 37.5% salt by weight and TA 68 contained 56.25% salt by weight (Table XIII). Approximately 0.3 grams of each composition was formed into a ball. The ball forming action is simply done by rolling the material with ones fingers. The compositions have good cohesion and the ball readily forms. The formed ball is placed in 60 mL of distilled water (Walmart). The water conductivity is measured over time. The solution is stirred before a reading is recorded. Once the conductivity measurement reaches steady state, the ball is recovered, reformed and placed in the original 60 mL water. Conductivity measurements continue until no further increase is observed.

TABLE XIII
Composition Used for Trials: TA-67 and TA-68

| Composition Used for Trials | TA-67 (grams) | TA-68 (grams) |
|---|---|---|
| Cellulose Ester | 7.8 | 2 |
| Plasticizer | 19.5 | 3 |
| Filler/Attractant | 35.1 | 0 |
| Sodium Chloride | 37.5 | 9 |
| Corn Starch | 0 | 2 |

Equipment:

EZ-1 Total Dissolved Solids, Electrical Conductivity Meter, Temperature test pen

Small plastic container to hold 60 mL of distilled water

Results:

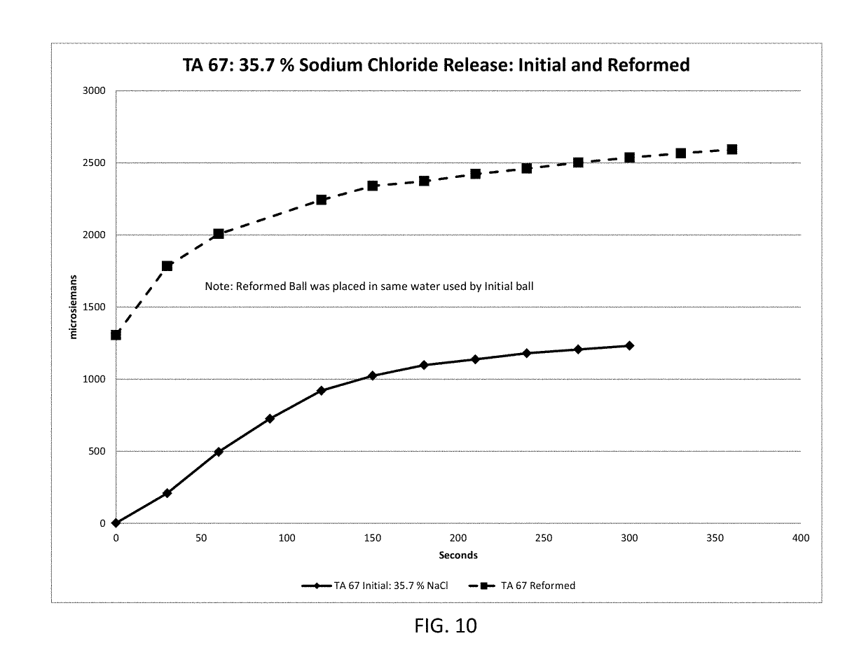

FIG. 10 shows the release profiles of TA-67. The solid line shows the initial salt release profile and the dashed line shows the rejuvenated ball salt release profile. The initial point of the rejuvenated release curve was plotted at time=0 for convenience. The actual time profile would have continued at the end of the solid line. Both curves show high initial releases and then the release slows to a linear release rate. Regression lines were added to latter points of the curves. The correlation coefficients are 0.9864 and 0.993 for the initial and rejuvenated curves respectively. The key finding is that the reformed ball continues to have a high sustained release profile. This trait allows the fisherman to extend the useful life of a single bait without loss of effectiveness.

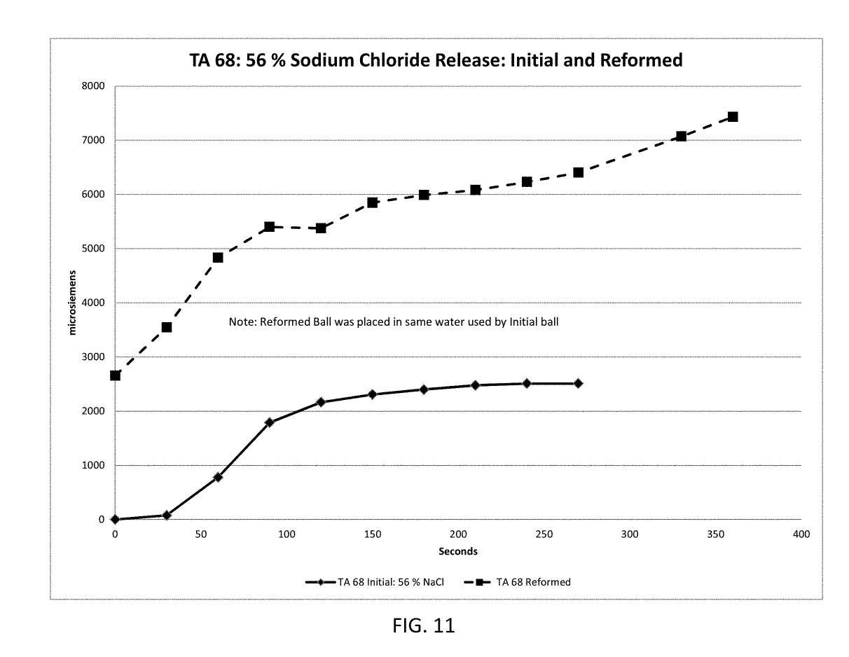

FIG. 11 shows the release profiles of TA-68. The release profile is more rapid with the higher salt composition. Like TA-67, the used TA-68 ball can be rejuvenated and the release profile continues.

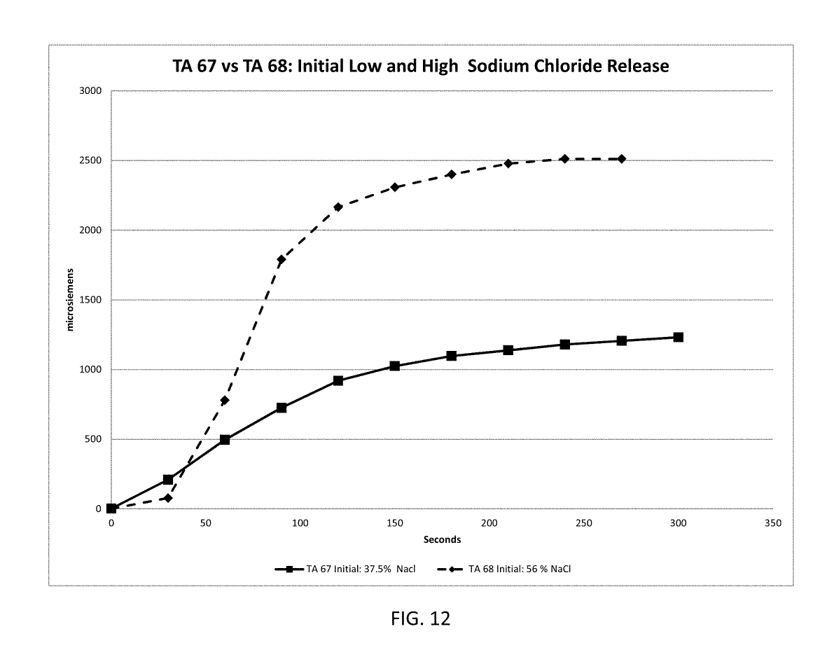

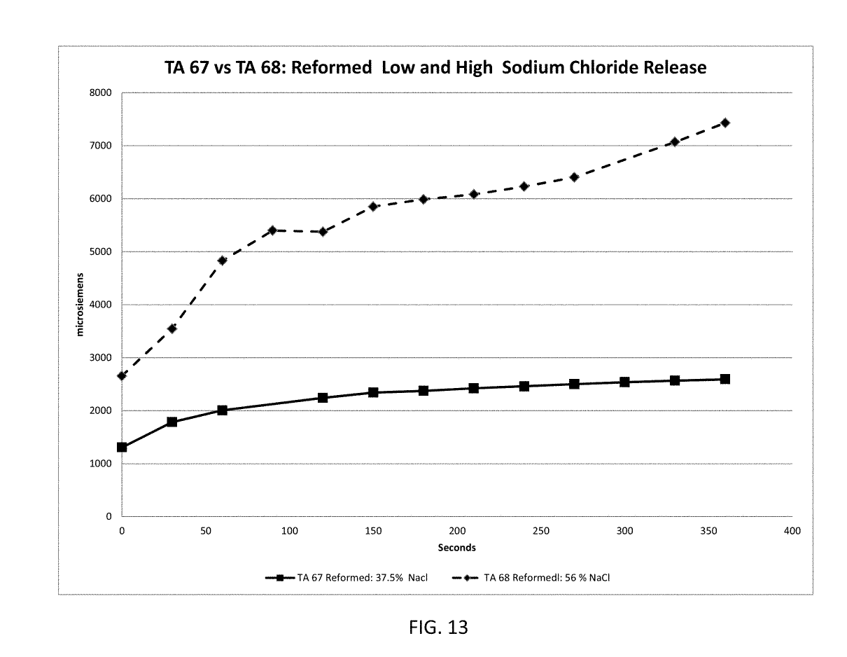

FIGS. 12-13 compare the initial and rejuvenated release profiles of TA-67 vs. TA-68. These results demonstrate that the salt concentration is directly proportional to release rate and the release rate is mass transfer control. Additionally, the release rate can be altered by using less water soluble material such as crawdad oil.

The TA-67 composition had a total release time of 11 minutes. The TA-68 composition had a total release time of 10.5 minutes.

### EXAMPLE 4

### Fish Putty Mixing Procedure

The filler compositions illustrate how to mix the ingredients (Table XIV).

1. Weigh 2 grams of cellulose ester in a properly sized container.

2. Add 5 grams of plasticizer to step 1, mix and allow to stand for 10 minutes at room temperature.

3. After 10 minutes, re-mix cellulose ester/plasticizer mixture. A soft ball or mass will form.

4. Add 9 grams of the filler, mix until homogenous at room temperature. This process will create a matrix with cohesion that can be formed into various shapes.

TABLE XIV
Filler Composition

| Ingredient | Weight - grams | Percentage |
|---|---|---|
| Cellulose Ester | 2 | 12.5 |
| Plasticizer | 5 | 31.3 |
| Filler/Attractant | 9 | 56.3 |
| Total | 16 | |

The following attractants are readily compounded into the filler compositions. One is not limited to this attractant list and any attractant can be used. These materials can be added at the 0.1-50% concentration by weight.

Fish food (ground), shrimp shred fluff, Fish Hydrolysate, cheese, commercial fish foods (ground), molasses, salt, garlic, anise, vanilla, amino acids and combinations, or any attractant previously described in this disclosure.

Oils, such as fish oil, crawdad oil and corn oil are pre-mixed with the corn flour. Once the corn absorbs the oil, the composition is mixed as described above. Oils are added in an amount ranging from 0.1 -10% by weight.

Triacetin has several functions in these compositions. The main function is a plasticizer for cellulose esters. The secondary function is as an antifungal and biocide (see Quinn, Michael J., Salice, Christopher J., Ziolkowski, David J., Wildlife Toxicity Assessment for Triacetin, U.S. Army Public Health Command, Public Health Notice (PHN) No. 0512-2, May 2012). The antifungal and biocide properties allow one to use organic materials and prevent spoilage in the composition.

The present invention has been described with reference to particular embodiments having various features. In light of the disclosure provided above, it will be apparent to those skilled in the art that various modifications and variations can be made in the practice of the present invention without departing from the scope or spirit of the invention. Additionally, it will be understood that the compositions described herein can be used or modified for use for baiting any aquatic creature, including both marine and freshwater fish, arthropods, cephalopods, echinoderms, amphibians, reptiles, mammals, and the like, as well as non-aquatic creatures such as insects, rodents, coyotes and other nuisance pests, as well as deer, elk, and other sports species. One skilled in the art will recognize that the disclosed features may be used singularly, in any combination, or omitted based on the requirements and specifications of a given application or design. When an embodiment refers to “comprising” certain features, it is to be understood that the embodiments can alternatively “consist of” or “consist essentially of” any one or more of the features. Other embodiments of the invention will be apparent to those skilled in the art from consideration of the specification and practice of the invention.

It is noted in particular that where a range of values is provided in this specification, each value between the upper and lower limits of that range is also specifically disclosed. The upper and lower limits of these smaller ranges may independently be included or excluded in the range as well. The singular forms “a,” “an,” and “the” include plural referents unless the context clearly dictates otherwise. It is intended that the specification and examples be considered as exemplary in nature and that variations that do not depart from the essence of the invention fall within the scope of the invention. Further, all of the references cited in this disclosure including patents, published patent applications, journal articles, and other articles are each individually incorporated by reference herein in their entireties and as such are intended to provide an efficient way of supplementing the enabling disclosure of this invention as well as provide background detailing the level of ordinary skill in the art.

1. A composition comprising:
at least one cellulose ester,
at least one plasticizer, and
one or more attractants.

2. The composition of claim 1, comprising by weight 1-30% cellulose ester, 10-70% plasticizer, 0.1-80% attractant, and/or 0-80% of a filler.

3. The composition of claim 1, comprising by weight 1-15% cellulose ester, 15-60% plasticizer, 5-70% attractant, and/or 30-70% of a filler.

4. The composition of claim 1, comprising by weight 11-13% cellulose ester, 20-30% plasticizer, 23-25% attractant, and/or 28-31% of a filler.

5. The composition of claim 1, wherein the cellulose ester is cellulose acetate, cellulose acetate propionate, or cellulose acetate butyrate, or combinations thereof.

6. The composition of claim 1, wherein the cellulose ester is cellulose acetate propionate.

7. The composition of claim 6, wherein the plasticizer is triacetin or acetyl triethyl citrate.

8. The composition of claim 1, wherein the plasticizer is poly(ethylene glycol), poly(ethylene succinate), arabinoxylan acetate, poly(caprolactone), poly(vinyl acetate), poly(N-vinyl pyrrolidone), polyaniline, polyvinyl phenol, poly(acryoyl morpholine), triacetin, triethyl citrate, tributyl citrate, acetyl triethyl citrate, acetyl tributyl citrate, sulfonamides, n-ethyl toluene sulfonamide, dibasic esters, dimethyl adipate or dialkyl esters of carboxylic acids C2-C10.

9. The composition of claim 1, wherein the one or more attractants are chosen from one or more of shrimp, earthworms, mealworms, fish meal, fish powder, crab meal, squid meal, fish hydrolysate, fish products, fish food, wax worms, anise, garlic, wheat, aquaculture byproducts, marine waste products, corn, sodium chloride, sea salt, Epsom salt, inorganic salts, trace mineral salts, butyric acid, fish oil, crawfish oil, shrimp oil, meat meal products, powdered bone meal, powdered food solids, rhodinyl acetate, dried slaughterhouse waste products, powdered fish, egg, dried milk products, molasses, cheese, fish powders, aquaculture by-products, and synthetic spices having a smell similar to that of fish meal, stale fish, shell fish, hill powder, pulverized dried sardine, spray dried inactivated and/or autolyzed yeast, powdered squid, borax, wood flour, bentonite, pulp fibers, and cellulosic materials, dicarboxylic amino acids, glutamic and aspartic acids, betaine, amino acids, glycine, alanine, taurine, tryptamine, and tyramine, or combinations thereof.

10. The composition of claim 1 further comprising one or more fillers chosen from one or more of corn products, corn flour, corn meal, starches, modified starches, maltodextrin, grain flour, meal, and gelatin, and combinations thereof.

11. The composition of claim 1, wherein, when soaked in water for 10 minutes or longer, placed on a hook, and subjected to a casting event of 2 seconds or longer under a centrifugal force of at least about 1 newton or under an angular acceleration of at least about 1500 m/sec², the composition remains on the hook throughout the casting event.

12. The composition of claim 1, which exhibits sustained release of the attractant for at least about 10 minutes when submerged in water.

13. A method of manufacture of the composition of claim 1, comprising:
mixing a cellulose ester with plasticizer until a soft ball or mass forms,
mixing one or more attractants with the cellulose ester and plasticizer,
wherein optionally the method is performed at room temperature.

14. A sculptable and moldable attractant comprising:
at least one cellulose ester; and
at least one attractant agent;
wherein the attractant agent is subject to controlled release or extended release.

15. The attractant of claim 14, wherein the at least one attractant agent is chosen from one or more food source or processed fish food or flavoring is chosen from one or more of shrimp, earthworms, mealworms, fish meal, fish hydrolysate, fish powder, fish products, fish food, wax worms, cheese, anise, garlic, corn, salt, sea salt, Epsom salt, trace mineral salt, inorganic salts, butyric acid, fish oil, crawfish oil, shrimp oil, and meat meal products, and combinations of one or more of these.

16. The attractant of claim 14, which is capable of withstanding a centripetal force of 0.001 newtons to 3 newtons, or an angular acceleration of 1 to 1500 m/sec², or a simulated casting motion under a force of at least 0.001 newton at least 2 times.

17. The composition of claim 1 further comprising at least one flexible tail comprising a polymer.

18. The composition of claim 17, wherein the flexible tail is molded with a flexible barb or has an expandable serrated end that can be inserted into a soft bait composition.

19. The composition of claim 17, wherein the polymer is a plastisol formulation.

20. A two-part tail configured for insertion into a bait composition, the two-part tail comprising a flexible plastisol tail comprising a base in communication with a barb-type connector and one or more tentacle-like projections extending from the base in a direction opposite the barb-type connector.
